(19) United States
(12) Patent Application Publication
(10) Pub. No.: US 2005/0248270 A1
(43) Pub. Date: Nov. 10, 2005

(54) Encapsulating OLED devices

(75) Inventors: Amalkumar P. Ghosh, Rochester, NY (US); Michael L. Boroson, Rochester, NY (US); Fridrich Vazan, Pittsford, NY (US); Joseph E. Yokajty, Webster, NY (US); George R. Olin, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/839,513

(22) Filed: May 5, 2004

(51) Int. Cl. H05B 33/04; H05B 33/00

(52) U.S. Cl. 313/512; 313/511; 313/504; 313/506

(57) ABSTRACT

An encapsulated OLED device includes a substrate having a predetermined glass seal area and defining a sealed region and one or more OLED unit(s) provided over the substrate, each OLED unit having a light-emitting portion including at least one first electrode, at least one second electrode spaced from the first electrode, and an organic EL media layer provided between the first and second electrodes, wherein the light-emitting portion is provided within the sealed region. The device also includes an inorganic protection layer provided over the glass seal area and over at least a portion of the sealed region, a cover provided over the substrate and OLED unit(s), and sintered glass frit seal material provided in the glass seal area and in contact with both the cover and the inorganic protection layer to bond the cover to the inorganic protection layer and provide sealing against moisture penetration into the sealed region.

### CROSS REFERENCE TO RELATED APPLICATIONS

Reference is made to commonly assigned U.S. patent application Ser. No. 10/807,486 filed Mar. 23, 2004 by Fridrich Vazan et al., entitled “Encapsulating OLED Devices,” the disclosure of which is herein incorporated by reference.

### FIELD OF THE INVENTION

The present invention relates to protecting OLED devices from ambient moisture.

### BACKGROUND OF THE INVENTION

Organic light-emitting diode (OLED) devices, also referred to as organic electroluminescent (EL) devices or OLEDs, have numerous well known advantages over other flat-panel display devices currently in the market place. Among these advantages are brightness of light emission, relatively wide viewing angle, reduced electrical power consumption compared to, for example, liquid crystal displays (LCDs) using backlighting, and a wider spectrum of colors of emitted light in full-color OLED displays.

Applications of OLED devices include active matrix image displays, passive matrix image displays, and area lighting devices such as, for example, selective desktop lighting devices. Irrespective of the particular OLED device configuration tailored to these broad fields of applications, all OLEDs function on the same general principles. An organic electroluminescent (EL) medium structure is sandwiched between two electrodes. These electrodes are commonly referred to as an anode and a cathode in analogy to the terminals of a conventional diode. Typically, one of the electrodes is light transmissive. When an electrical potential is applied between the electrodes so that the anode is connected to the positive terminal of a voltage source and the cathode is connected to the negative terminal, the OLED is said to be forward biased. Positive charge carriers (holes) are injected from the anode into the organic EL medium structure, and negative charge carriers (electrons) are injected from the cathode. Such charge carrier injection causes current flow from the electrodes through the organic EL medium structure. Recombination of holes and electrons within a zone of the EL medium structure results in emission of light from this zone.

It is often the case that light is emitted through the OLED substrate in a so-called “bottom-emitting” configuration. However, “top-emitting” OLED devices are contemplated that emit light through the side opposite the OLED substrate. This has the advantage that the OLED substrate does not need to be transparent. This permits more degrees of freedom in choosing a substrate. Further, top-emitting active matrix OLED devices can have much more complex circuitry because the light does not need to be emitted through the thin film transistors (TFTs), capacitors, wiring lines, etc.

Despite their advantages, unprotected OLED display devices are prone to rapid degradation of performance due to adverse effects of oxygen and/or moisture present in the ambient environment. Additionally, unprotected devices can be subject to mechanical damage caused by abrasion. Various efforts have been directed at providing packaged OLED displays in which the packaging approaches offer improved operational lifetime of displays, which is still limited so that widespread adoption of OLED display devices is currently restricted.

For sealing of the organic electroluminescence element, mainly two methods have been studied so far. One is to form a protective film on the outer surface of the organic electroluminescence element by using vacuum film-forming technology such as vapor deposition method, and the other is to adhere a shield material such as a metal or glass cover to the organic electroluminescence element.

A method of sealing an OLED by forming a protective film is disclosed, for example, in Japanese Laid-open Patent 06-096858, which relates to a method of forming GeO, SiO, AlF3, or the like on the outer surface of the organic electroluminescence element. However, it is very difficult to completely seal an OLED using a protective film alone. So-called “dark spots” are a common problem, and are often attributable to the presence of dust particles. Dust particles are typically much larger in size than the thickness of the OLED or typical protective films. Unfortunately, most thin film coating methods do not completely seal the dust particles, and a path for moisture penetration can still occur.

A method of sealing the organic electroluminescence element by adhering a shield material is found in U.S. Pat. No. 6,226,890, which discloses the use of an enclosure that is bonded to an OLED substrate using a curable resin. Because the curable resin permits some moisture penetration, the enclosure further contains a desiccant. However, desiccant can be expensive. In addition, if light emission is designed to occur through the enclosure, the enclosure must be transparent and the desiccant must be either transparent or applied in areas where there is no light emission. This can result in further increases in manufacturing costs. If desiccant is limited only to areas where there is no light emission, there can be insufficient area to ensure adequate moisture protection, thus reducing the life of the display. By increasing the non-light-emitting area, more desiccant can be provided. This provides a problem because it may reduce efficiency and increase display size.

It has been proposed to use a low melting glass to seal a shield to a substrate, e.g., as disclosed in U.S. Pat. No. 6,195,142. In this method, a laser can be used to provide local heating and melt (sinter) the glass sealant. Although this can result in a seal having very low water permeability, it has been found that the laser can damage the electrode lines. This damage results in greatly reduced conductivity in the glass seal area and much higher driving voltages or even device failure.

There still remains a need to provide a functional OLED device having reliable protection from moisture. In particular, there remains a need to provide such an OLED in a top-emitting format.

### SUMMARY OF THE INVENTION

It is therefore an object of the present invention to provide an OLED having excellent protection against moisture. It is another object of this invention to provide a moisture seal that has good adhesion and does not degrade the electrical properties of the OLED device. It is another object of this invention to provide a sealing step that has increased manufacturing robustness.

The objects are achieved by an encapsulated OLED device comprising:

a) a substrate having a predetermined glass seal area and defining a sealed region;

b) one or more OLED unit(s) provided over the substrate, each OLED unit having a light-emitting portion including at least one first electrode, at least one second electrode spaced from the first electrode, and an organic EL media layer provided between the first and second electrodes, wherein the light-emitting portion is provided within the sealed region;

c) an inorganic protection layer provided over the glass seal area and over at least a portion of the sealed region;

d) a cover provided over the substrate and OLED unit(s); and

e) sintered glass frit seal material provided in the glass seal area and in contact with both the cover and the inorganic protection layer, so as to bond the cover to the inorganic protection layer and provide a seal against moisture penetration into the sealed region.

### Advantages

The present invention provides excellent protection for an electronic device against moisture, increases the bond strength between a cover and device, and does not degrade the electrical properties of the device. The present invention also provides increased manufacturing robustness in the sealing step. The invention can be used in a top-emitting OLED which has the advantage that the substrate does not need to be transparent, and permits for higher aperture ratios for emitting elements and more complex circuitry on the substrate.

### BRIEF DESCRIPTION OF THE DRAWINGS

FIG. 1 is a plan view of a substrate and a first electrode of an OLED device to be fabricated in a first embodiment of the invention;

FIG. 2 is a plan view of the first embodiment of the invention after deposition of the organic EL media layer and the second electrode;

FIG. 3A is a plan view the first embodiment of the invention after deposition of the inorganic protection layer;

FIG. 3B is a cross-sectional view of the device from FIG. 3A taken along line 3A;

FIG. 4A is a plan view of a cover patterned with glass frit seal material;

FIG. 4B is a cross sectional view of the cover from FIG. 4A taken along line 4A;

FIG. 5 shows the sealing of the OLED device by localized heating of the glass frit;

FIG. 6 shows a cross-sectional view of an encapsulated OLED device in the first embodiment of this invention;

FIG. 7 shows a cross-sectional view of an encapsulated OLED device in a second embodiment of this invention;

FIG. 8 is a plan view of a substrate and a first electrode of an OLED device to be fabricated in a third embodiment of the invention;

FIG. 9 is a plan view of the third embodiment of this invention after deposition of the inorganic insulation and protection layer;

FIG. 10A is a plan view of the third embodiment after deposition of organic EL media and the second electrode;

FIG. 10B is a cross-sectional view from FIG. 10A taken along line 10A;

FIG. 10C is a cross-sectional view from FIG. 10A taken along line 10B;

FIG. 11 shows a cross-sectional view of the encapsulated OLED device according to the third embodiment of this invention;

FIG. 12 shows a cross-sectional view of an encapsulated OLED device according to a fourth embodiment of this invention;

FIG. 13 shows a cross-sectional view of an encapsulated OLED device according to a fifth embodiment of this invention;

FIG. 14 shows a cross-sectional view of an encapsulated OLED device according to a sixth embodiment of this invention;

FIG. 15 shows a cross-sectional view of the OLED device from FIG. 10B after deposition of an organic barrier layer;

FIG. 16 shows a cross-sectional view of the OLED device from FIG. 15 after deposition of a patterned inorganic barrier layer;

FIG. 17 shows the OLED device from FIG. 16 after patterning of the organic barrier layer;

FIG. 18 shows the OLED device from FIG. 17 after deposition of the inorganic protection layer;

FIG. 19 shows a cross-sectional view of an encapsulated OLED device according to a seventh embodiment of this invention; and

FIG. 20 shows the various layers of a typical OLED device.

The drawings are necessarily of a schematic nature since layer thicknesses are frequently in the sub-micrometer range and pixel dimensions can be in a range of from 5-250 micrometer, while lateral dimensions of substrates can be in a range of from 10-50 centimeter. Accordingly, the drawings are scaled for ease of visualization rather than for dimensional accuracy.

### DETAILED DESCRIPTION OF THE INVENTION

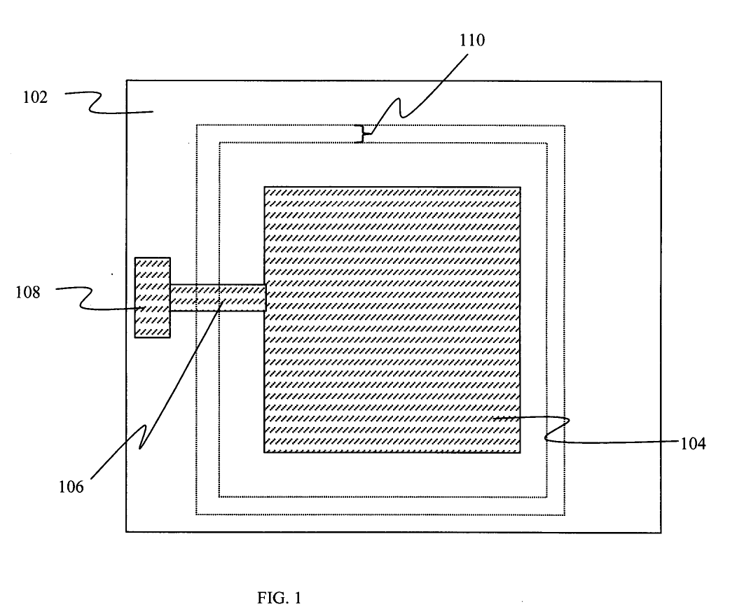

As a first embodiment, FIGS. 1-6 illustrate various stages of the fabrication of encapsulated OLED device 100. Turning first to FIG. 1, a plan view of an OLED substrate 102 is shown. A predetermined glass seal area 110 is represented by the space between the dotted lines in FIG. 1. The inner dotted line of the glass seal area 110 further represents the sealed region of the OLED device. Over OLED substrate 102 are provided a first electrode 104, a first electrical contact pad 108, and a first interconnect line 106 that provides an electrical connection between the first electrode 104 and the first electrical contact pad 108. The first electrical contact pad 108 is provided outside of the sealed region, the first electrode 104 is provided inside the sealed region, and the first interconnect line 106 is provided in both regions, and extends through the glass seal area. As discussed later, the first electrode 104 can be the anode or cathode, and can be any number of well known conductive materials including metals, metal oxides, and conductive polymers. The conductive material used for each of the first electrode 104, the first interconnect line 106, and the first contact pad 108 can be the same or different. In addition, each of the first electrode 104, the first interconnect line 106, and the first contact pad 108 can contain two or more layers of different conductive materials.

The conductive materials for forming the first electrode 104, the first interconnect line 106, and the first contact pad 108 can be deposited by vacuum methods such as thermal physical vapor deposition, sputter deposition, plasma-enhanced chemical vapor deposition (PECVD), electron-beam assisted vapor deposition, and other methods as well known in the art. In addition, so-called “wet” chemical processes can be used such as electroless and electrolytic plating. The first electrode 104, the first interconnect line 106, and the first contact pad 108 can be provided in the same patterning step or different patterning steps. Patterning can be achieved by deposition through a shadow mask, photolithographic methods, laser ablation, selective electroless plating, electrochemical etching, and other patterning techniques known by those skilled in the art.

In this embodiment, the first electrode 104, the first interconnect line 106, and the first contact pad 108 are made from transparent indium tin oxide (ITO), and the first electrode will function as the anode of encapsulated OLED device 100.

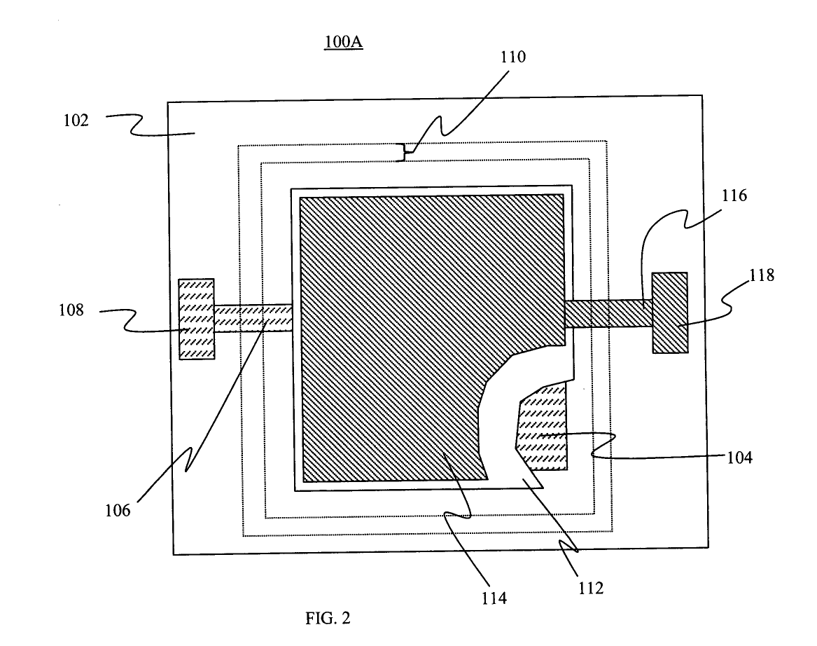

Turning now to FIG. 2, an organic EL media layer 112 and a second electrode 114 are provided over the first electrode. A second electrical interconnect 116 and a second contact pad 118 are also provided. This assembly represents the OLED device 100A prior to encapsulation. The second interconnect line 116 extends through the glass seal area 110 and electrically connects the second electrode 114 to the second contact pad 118. To illustrate the layer order, the lower right corner of first electrode area is pictorially cut away to show the first electrode 104. The organic EL media layer 112 is described in more detail below, but it can contain one or several layers of different materials. In this embodiment, the organic EL media layer 112 is provided over the entire first electrode 104 and over a portion of the first interconnect 106, and it preferably extends beyond the edges of the first electrode 104. This prevents shorting between the second electrode 114 and the first electrode 104 or first interconnect 106. The organic EL media layer 112 is not provided in the glass seal area. The second electrode 114 is patterned so as not to contact the first electrode 104 or first interconnect 106.

The light-emitting portion (pixel) is defined by the area of overlap of the first electrode 104 (and perhaps some of the first interconnect 106) with the second electrode 114 (and perhaps some of the second interconnect 116), wherein there is organic EL media sandwiched in between. This light-emitting portion is conveniently referred to as an OLED unit. It will be apparent to one skilled in the art that a plurality of OLED units can be provided in the manner described in FIGS. 1 and 2. Further, the plurality of OLED units can have the same organic EL media, or different organic EL media that emit light of different colors. For example, the plurality of OLED units can emit red, green, and blue light. The structure in FIG. 2 represents the OLED device 100A prior to deposition of any protection layers or encapsulation. The first and second electrodes and the organic EL media layer are provided within the sealed region.

The second electrode 114, the second interconnect 116, and the second contact pad 118 can be deposited and patterned using methods previously described for the first electrode 104, first interconnect 106 and the first contact pad 108. However, wet chemical methods are usually not preferred if the organic EL media has been deposited by vapor deposition. If the first electrode is the anode, then the second electrode is selected to function as the cathode. If the first electrode is selected to function as the cathode, then the second electrode is selected to function as the anode. In this particular embodiment the second electrode 114, the second interconnect 116, and the second contact pad 118 are formed in a single patterning step and are made from aluminum, and the second electrode 114 functions as the cathode.

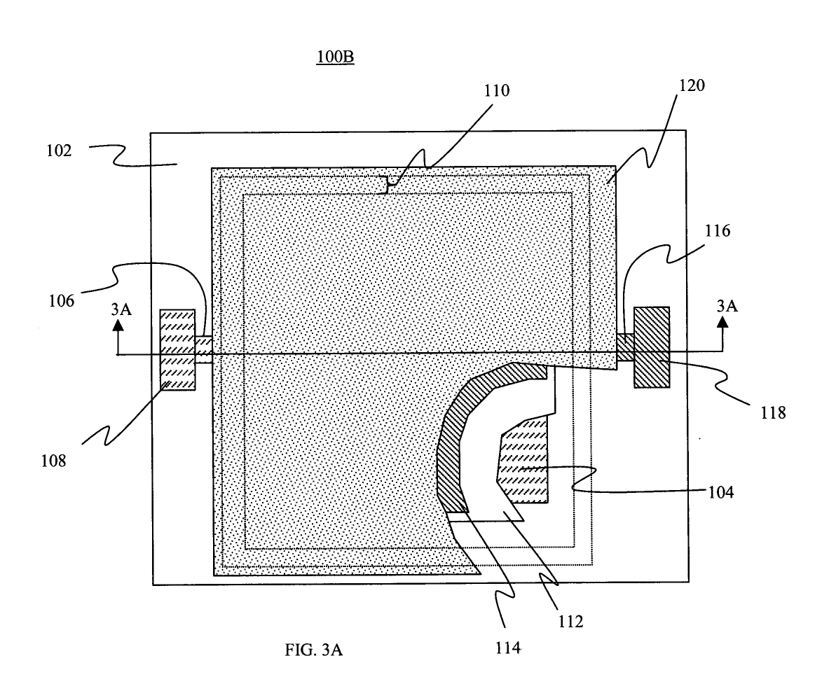

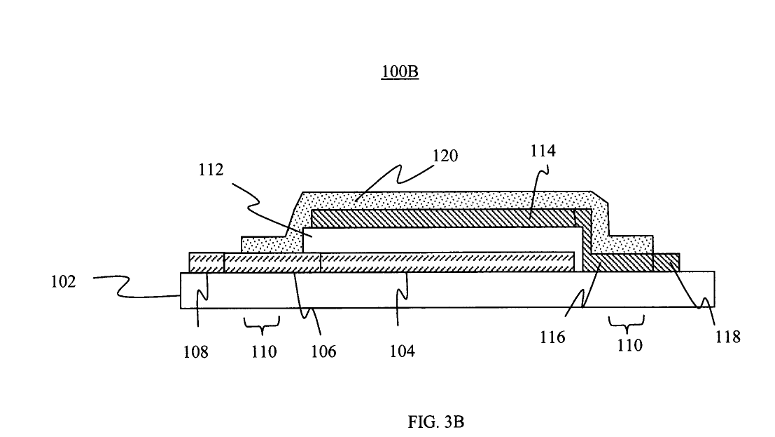

Turning now to FIG. 3A, an inorganic protection layer 120 is provided over the OLED device such that the layer extends through the glass seal area 110 but not over the first or second contact pads 108 and 118. A cross-sectional view along line 3A is shown in FIG. 3B. These figures represent the OLED device 100B after deposition of the inorganic protection layer, but prior to encapsulation. It is envisioned that the inorganic protection layer 120 can extend over the first or second contact pads but, in order to make electrical connection, at least a portion of the first or second contact pads must not be covered. The inorganic protection layer is provided over all of the glass seal area and over at least a portion of the sealed region. Preferably, as shown in FIG. 3A, the inorganic protection layer is provided over the entire sealed region.

The inorganic protection layer 120 can be selected from any number of inorganic materials provided that the material has low electrical conductivity, has good heat resistance, and provides good adhesion with the glass frit seal material and the surfaces over which it is applied. The inorganic protection layer protects underlying layers from unwanted chemical reactions or physical changes caused by the high temperatures that are produced during the glass-sealing step. When applied over the entire sealed region as shown in FIG. 3A, the inorganic protection layer 120 can protect the sensitive OLED unit(s) during handling in subsequent manufacturing steps and from moisture exposure before or after the glass-sealing step.

Some non-limiting examples of inorganic protection layer materials include metal oxides such as silicon oxides and aluminum oxides, and metal nitrides such as silicon nitride. Suitable examples of inorganic protection layer materials include aluminum oxide, silicon dioxide, silicon nitride, silicon oxynitride, and diamond-like carbon. The inorganic protection layer 120 is typically provided in a thickness of ten to several hundreds of nanometers.

Useful techniques of forming layers of inorganic protection layer material from a vapor phase include, but are not limited to, thermal physical vapor deposition, sputter deposition, electron beam deposition, chemical vapor deposition, plasma-enhanced chemical vapor deposition, laser-induced chemical vapor deposition, and atomic layer deposition. In some instances, said materials can be deposited from a solution or another fluidized matrix, e.g., from a super critical solution of CO₂. Care must be taken to choose a solvent or fluid matrix that does not negatively affect the performance of the device. Patterning of said materials can be achieved through many means including, but not limited to, photolithography, lift-off techniques, laser ablation, and shadow mask technology.

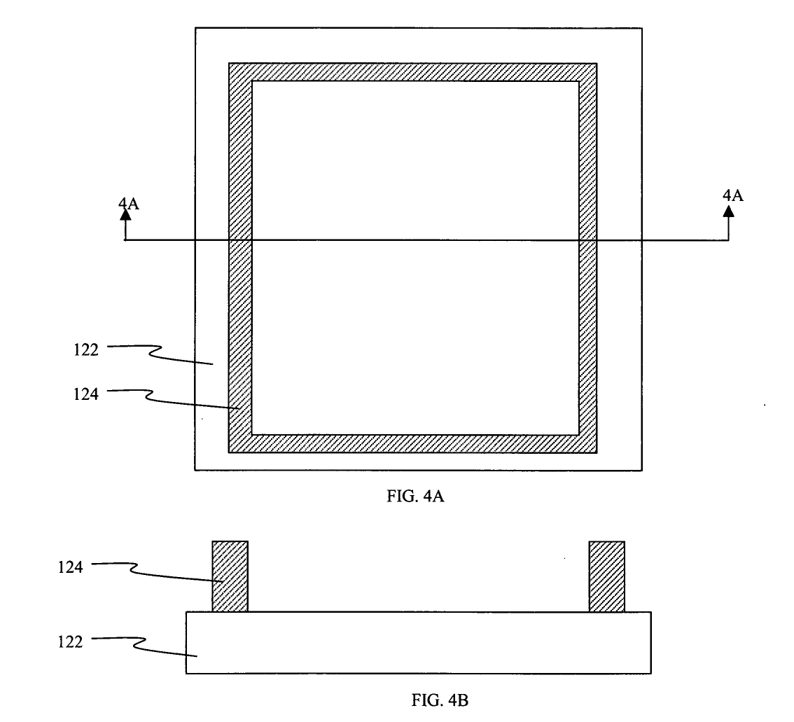

Turning now to FIG. 4A, a cover 122 is shown having deposited thereon glass frit seal material 124 in a pattern corresponding to the predetermined glass seal area 110. A cross-sectional view taken along line 4A is shown in FIG. 4B. The cover is preferably transparent glass, but can be metallic or some composite. A polymer cover can also be used if it is provided with a water impermeable layer(s) adjacent to the interface with the glass frit seal material, and if the polymer has sufficient high temperatures stability to withstand the sealing step. An adhesion promoting layer (not shown) can optionally be provided between the cover 122 and the glass frit seal material 124.

A useful glass frit seal material 124 must provide adequate flow at the sealing temperature in order to permit the glass to wet the inorganic protection layer and form a seal therewith. It is desirable to maintain the sealing temperature as low as possible to avoid damage to the OLED device, which has thermally sensitive parts and coatings. The glass frit seal material must also provide a coefficient of thermal expansion (CTE) that is compatible with the CTE of the substrate. Devitrifying glass frits based on PbO—ZnO—B₂O₃ compositions are useful. A small amount of a crystallization-inducing catalyst can optionally be added to a ball-milled base frit. The crystallization catalyst serves as a source of heterogeneous nucleation. After a brief period of flow at sealing temperatures, the frit will then undergo crystallization and become rigid. Other lead-based glass frit seal material systems are useful including, but not limited to, those based on Pb—B—Sn—Si—Al—O, Sn—P—Pb—O—F, Pb—Sn—P—O—Cl, and PbO—SnO—P₂O₅.

Despite utility of lead-based glass frit seal materials, there can be advantages to using a glass frit seal material that does not contain lead, in particular for health and safety reasons. Lead-free glass frit seal materials based on ZnO—SnO—P₂O₅ have been described in U.S. Pat. Nos. 5,246,890, 5,281,560, and 6,048,811. These glasses typically have compositions containing 25-65 mole % P₂O₅ and SnO and ZnO in amounts such that the mole ratio of SnO:ZnO is in the range of 1:1 to 5:1. The glass compositions can further contain CTE-modifying oxides such as SiO₂, B₂O₃, and Al₂O₃. These modifying oxides are usually present at a level of less than 20 mole %. The glass seal frit material can also contain one or more crystallization promoters such as zircon and/or zirconia, Ru₂O and BaTiO₃. Additionally, the composition can include small amounts of a seal adherence promoter such as WO₃, MoO₃, and Ag metal.

Glass frits seal materials are commonly mixed with an organic vehicle, such as amyl acetate, to form a flowable or extrudable paste. The organic material is typically present at less than 10% by weight. This mixture can then be extruded in a pattern onto the cover 122. The cover and glass frit seal material can then be baked at a temperature lower than the sealing temperature, but high enough to drive off the organic matrix and cause some sintering of the oxide particles. If necessary, the glass frit seal material 124 can then be polished to improve the uniformity of the frit surface that will be bonded to the OLED device.

In this embodiment, the cover substrate is transparent glass and the glass frit seal material is one that does not contain lead.

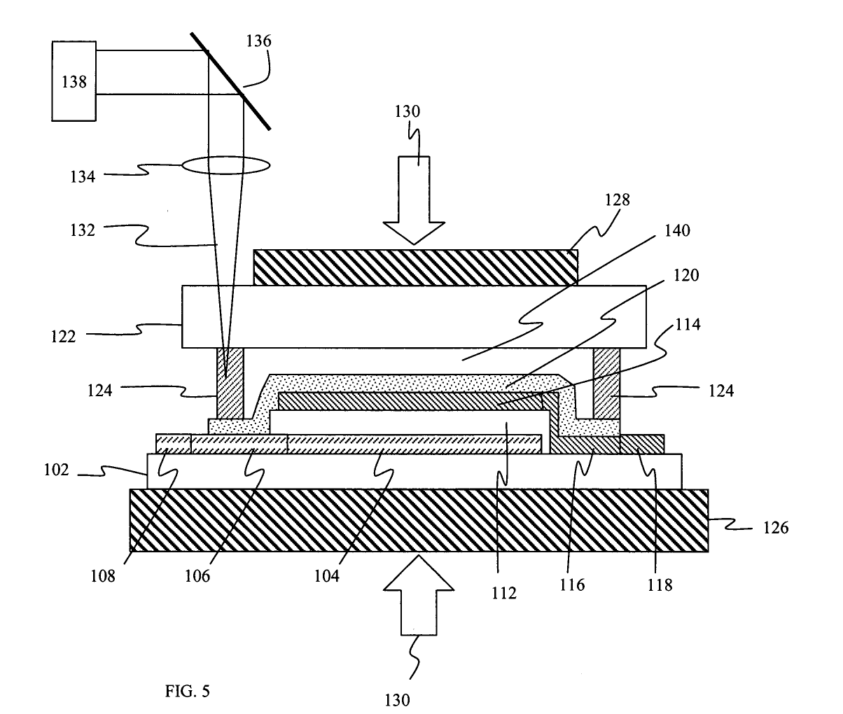

FIG. 5 illustrates the sealing of the cover to the OLED substrate. The OLED device 100A is provided on a pedestal 126. The cover 122 with the patterned glass frit seal material 124 is provided over the OLED device 100B in alignment with the predetermined seal area. A pressure plate 128 is provided over the cover 122. In sintering the glass frit seal material 124, a high-power beam 132 such as a laser beam or infrared ray can be used as the sintering source to provide strong heat within a very small region, thus the temperature at the periphery of the focused region is not high enough to produce thermal stress. Because of the presence of the inorganic protection layer 120, the sealing in this embodiment can be done in air. Preferably, the sealing step is done under inert conditions such as under vacuum or under a dry nitrogen or argon atmosphere. The nitrogen or argon atmosphere can be at a pressure lower or higher than atmospheric pressure. The sintered glass frit seal material bonds the cover to the inorganic protection layer and provides an excellent seal against moisture penetration into the sealed region.

During sealing of the OLED device, appropriate pressure 130 is applied to the pressure plate 128 and the pedestal 126. Preferably, metal materials with good thermal conductivity are used to form the pressure plate 128 and the pedestal 126. This aids in the dissipation of heat caused by the high-power beam. It is often desirable that the thickness of the OLED substrate be less than the distance between the glass seal area and the light-emitting pixel area. In this way, heat can be conducted efficiently through the OLED substrate to the pedestal, and away from the heat-sensitive organic EL media layer. Conveniently, the high-power beam 132 is a laser beam having a wavelength of more than 550 nm, such as a high-power diode laser of 800 nm wavelength and an Nd-YAG laser of 1064 nm wavelength. The high-power beam is produced by the high-power beam source 138, and can be directed to the desired location by optical components such as a mirror 136 and a lens 134. An X-Y-Z stage (not shown) can be used to align the cover to the OLED substrate or to direct the high-power beam to the proper location, or both.

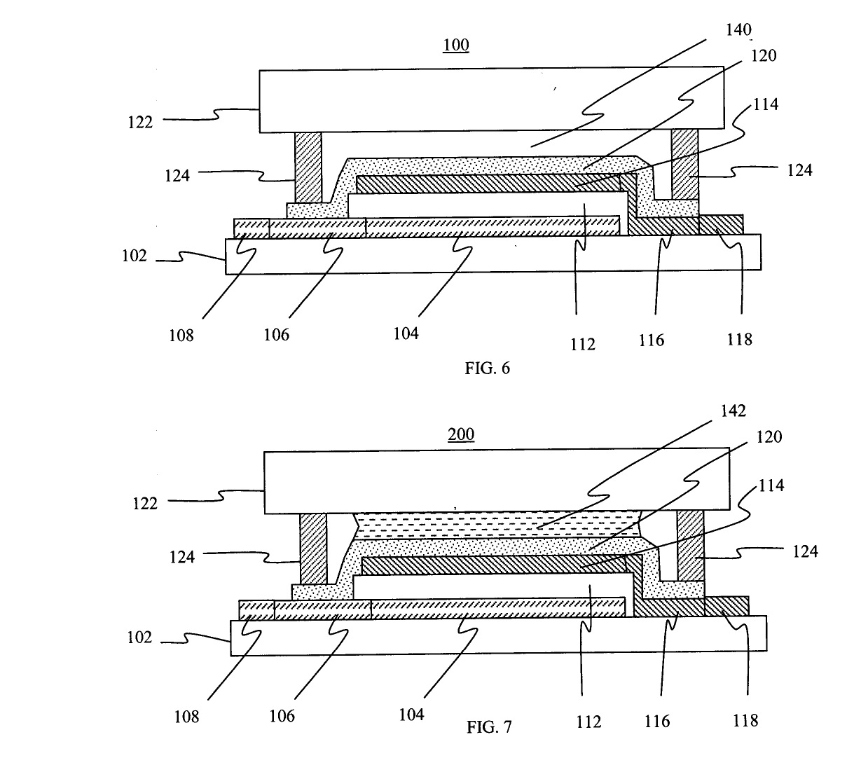

FIG. 6 shows the encapsulated OLED device 100. In this embodiment, there is a space 140 between the inorganic protection layer and the cover. If the sealing step is done under nitrogen or argon, this space is filled with these gasses. If the pressure in space 140 is slightly reduced relative to atmospheric pressure, there can be an advantage of maintaining a pressure between the cover and the OLED device to ensure a good seal. Further, if the space 140 is under slightly reduced pressure, then there is less chance of seal failure if the encapsulated OLED device is exposed to low pressures (e.g., transportation in the cargo bay of an airplane).

FIG. 7 shows another encapsulated OLED device 200 in a second embodiment of this invention. In this embodiment, a polymer buffer layer 142 is provided between the cover 122 and the inorganic protection layer 120. The polymer buffer layer 142 can be any number of materials including UV or heat cured epoxy resin, acrylates, or pressure sensitive adhesive. An example of a useful UV-curable epoxy resin is Optocast 3505 from Electronic Materials Inc. An example of useful pressure sensitive adhesive is Optically Clear Laminating Adhesive 8142 from 3M. Not shown, the polymer buffer layer can be provided either on the cover 122 or on the inorganic protection layer 120 prior to the glass-sealing. It preferably does not extend to the glass frit seal material 124. If applied to the cover glass, it should preferably be done after the glass frit seal material has been applied and baked. If the polymer buffer 142 layer requires a curing step, it can be performed prior to the glass-sealing step to permit for the outgassing of any possible byproducts of curing. For example, the cover 122 with the patterned glass frit seal material 124, and further having polymer buffer layer 142, is provided over the OLED device 100B in alignment with the predetermined seal area. The polymer buffer layer 142 is cured and then the glass-sealing step is carried out. If the curing step does not release harmful byproducts and does not raise the internal pressure such that the glass seal fails, then curing can be done after or concurrently with the glass-sealing step. Alternatively, the curing step can be initiated just prior to the glass-sealing step, and complete curing happens after or concurrently with the glass-sealing step. The polymer buffer layer 142 can provide additional adhesion between the cover 122 and the OLED device 100B. The layer can also aid the out-coupling of light if light is to be emitted through the cover. The polymer buffer layer 142 can optionally contain a desiccant or getter material.

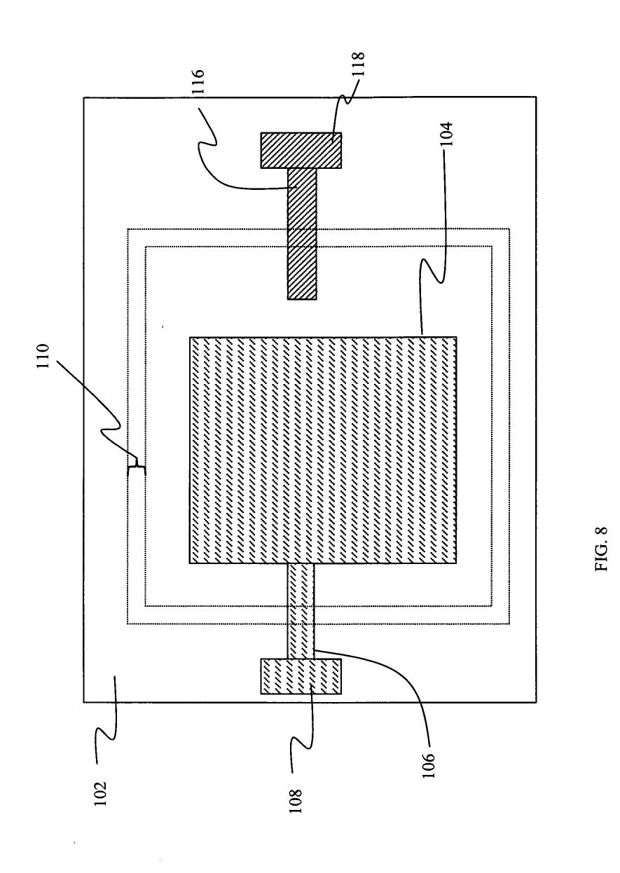

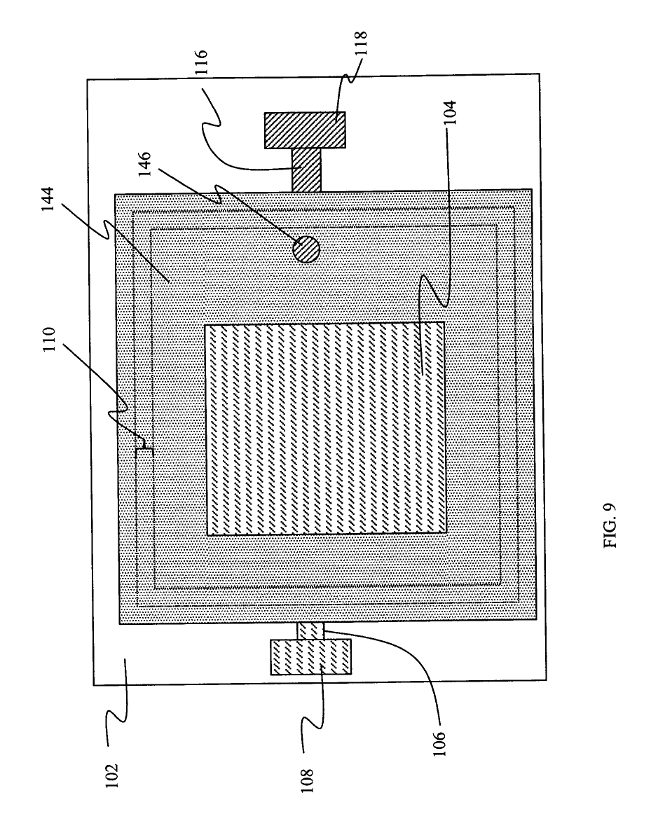

As another embodiment, FIGS. 8-10 illustrate various stages of the fabrication of encapsulated OLED device 300 in a third embodiment of this invention. As shown in FIG. 8, this embodiment is analogous to that shown in FIG. 1, except that the second interconnect 116 and the second contact pad 118 are provided over the OLED substrate 102 prior to the deposition of the organic EL media. In FIG. 9, an inorganic insulation and protection layer 144 is provided in a pattern over the OLED substrate 102. The inorganic insulation and protection layer 144 extends through the predetermined glass seal area 110 and over a portion of the first electrode 104, and over at least a portion of the first and second interconnects, 106 and 116. A via 146 is provided over the second interconnect area 116 that is located inside the sealed region.

The inorganic insulation and protection layer 144 can be any number of inorganic materials provided that the material has low electrical conductivity, has good heat resistance, and provides good adhesion with the glass frit seal material and the surfaces over which it is applied. The inorganic insulation and protection layer 144 protects underlying layers from unwanted chemical reactions or physical changes caused by the high temperatures that are produced during the glass-sealing step. In this regard, the inorganic insulation and protection layer 144 serves the same function as the inorganic protection layer 120 described previously. However, because the inorganic insulation and protection layer 144 is applied before the organic EL media and the second electrode, it does not serve to protect the sensitive OLED unit(s) during handling in subsequent manufacturing steps or from moisture exposure before or after the glass-sealing step.

Materials that are useful for the inorganic insulation and protection layer 144 include those defined previously for the inorganic protection layer 120. Some non-limiting examples of inorganic insulation and protection layer materials include metal oxides such as silicon oxides and aluminum oxides, metal nitrides such as silicon nitride, and ceramic composites. These materials can be deposited and patterned as described previously for the inorganic protection layer. In addition, the materials can be provided from a solution, such as a sol-gel. In some instances, it can be useful if the inorganic insulation and protection layer 144 further functions as a planarization layer to provide for a flat interface between the glass frit seal material and the OLED device. Alternatively, after the inorganic insulation and protection material is deposited, it can be polished or micro-milled to provide a flat surface. For the purposes of discussion, a sol-gel material that has high planarizing ability is used as the inorganic insulation and protection layer 144 in this embodiment.

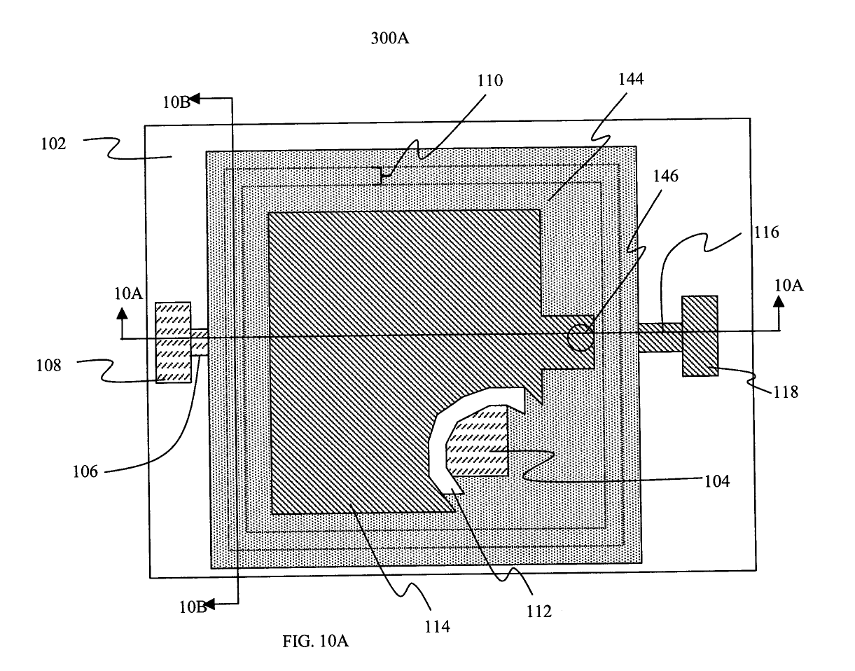

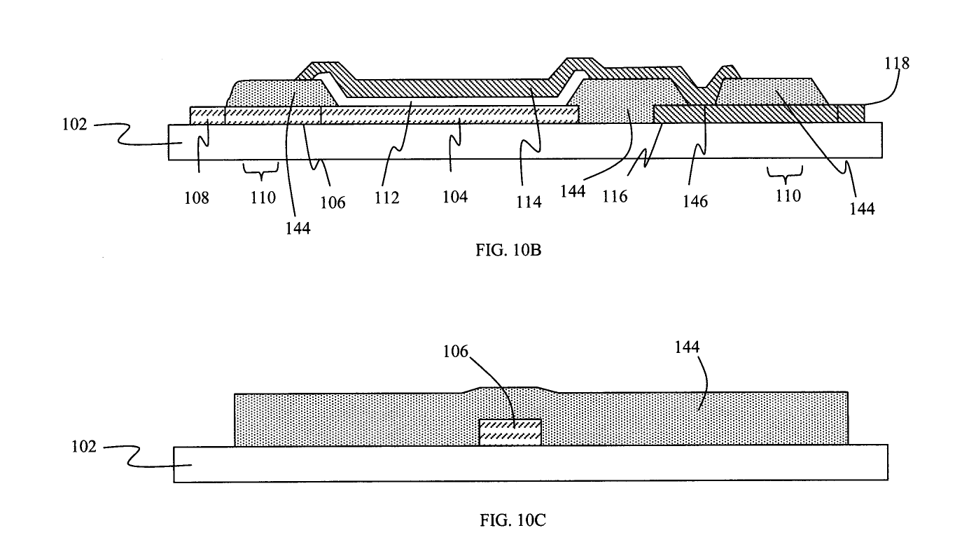

As shown in FIG. 10A, the organic EL media layer 112 and second cathode 114 are then deposited to make the OLED device 300A. To illustrate the layer order, the lower right corner of first electrode area is pictorially cut away to show the first electrode 104. Cross-sectional views of OLED device 300A taken along lines 10A and 10B are shown in FIGS. 10A and 10B, respectively. As can be seen in FIG. 10C, the inorganic insulation and protection layer 144 is highly planarizing in this embodiment.

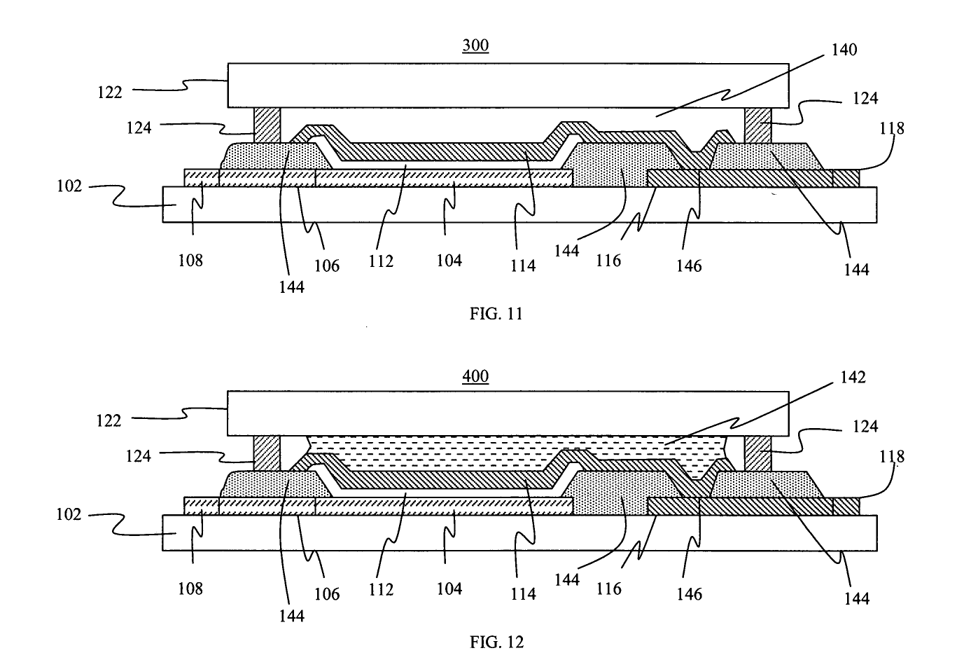

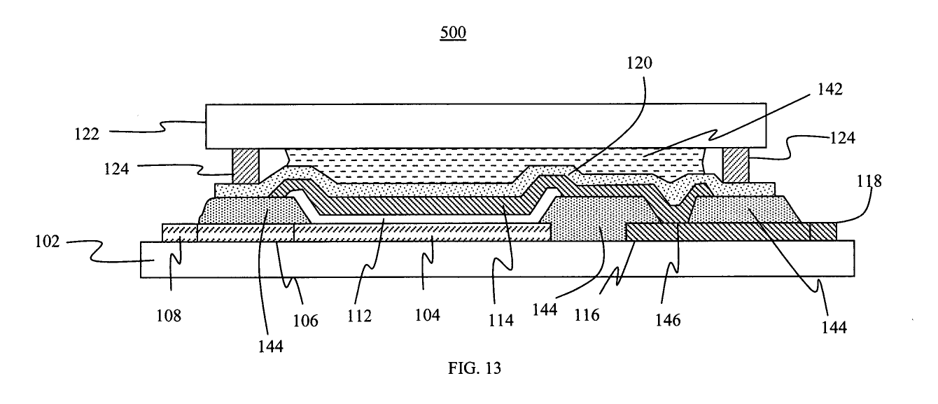

The encapsulated OLED device 300 is shown in FIG. 11 and can be produced using the same method as discussed in relation to FIG. 5. In addition, as shown in FIG. 12, encapsulated OLED device 400 can be produced in a fourth embodiment of this invention that has a polymer buffer layer analogous to that shown in FIG. 7. In a fifth embodiment, an inorganic protection layer 120 can be applied in a manner analogous to that discussed in relation to FIG. 3A. The resulting encapsulated OLED 500 is shown in FIG. 13. This can provide extra heat protection to the underlying layers, redundancy to moisture penetration so that the device is more robust, and improved adhesion of the OLED device to the glass frit seal material and/or the polymer buffer layer.

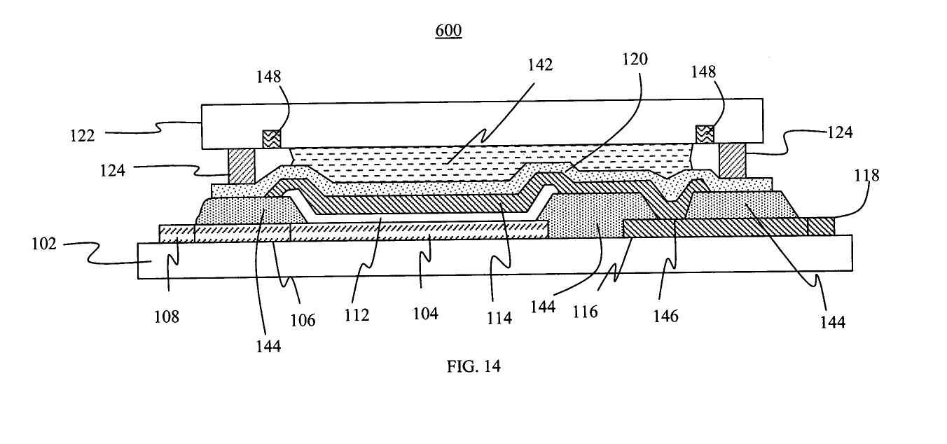

Although the encapsulated OLED devices described above have excellent protection against environmental moisture, additional protection can be made by supplying a desiccant. Although the glass-sealing step is done under dry conditions, there still could be a small amount of moisture entrapped in the device, or some outgassing of moisture from the polymer buffer layer. As shown in FIG. 14 in a sixth embodiment, an encapsulated OLED device 600 of this invention, a small amount of desiccant 148 or getter can be provided at the perimeter region of the cover between the glass frit sealing material and the polymer buffer layer. In this embodiment, desiccant 148 is provided within a groove patterned into the cover. In this way, the desiccant 148 will not interfere if light is emitted through the cover 122.

Alternatively, a desiccant can be provided over a large portion of the surface of the cover 122 (not shown). This is effective if light emission is through the OLED substrate 102 or if the desiccant 148 is transparent and can remain transparent upon absorption of moisture. As yet another alternative, the polymer buffer layer itself can include a desiccant or getter material.

Useful getters and desiccants include alkali and alkaline metals, alumina, bauxite, calcium sulfate, clays, silica gel, zeolites, alkaline metal oxides, alkaline earth metal oxides, sulfates, or metal halides and perchlorates. They can be deposited from a vapor or from solution, or they can be provided in a porous matrix. Particularly useful desiccants include those described in U.S. Pat. No. 6,226,890, which are provided in a polymeric matrix that can be patterned. Calcium metal is a particularly useful getter.

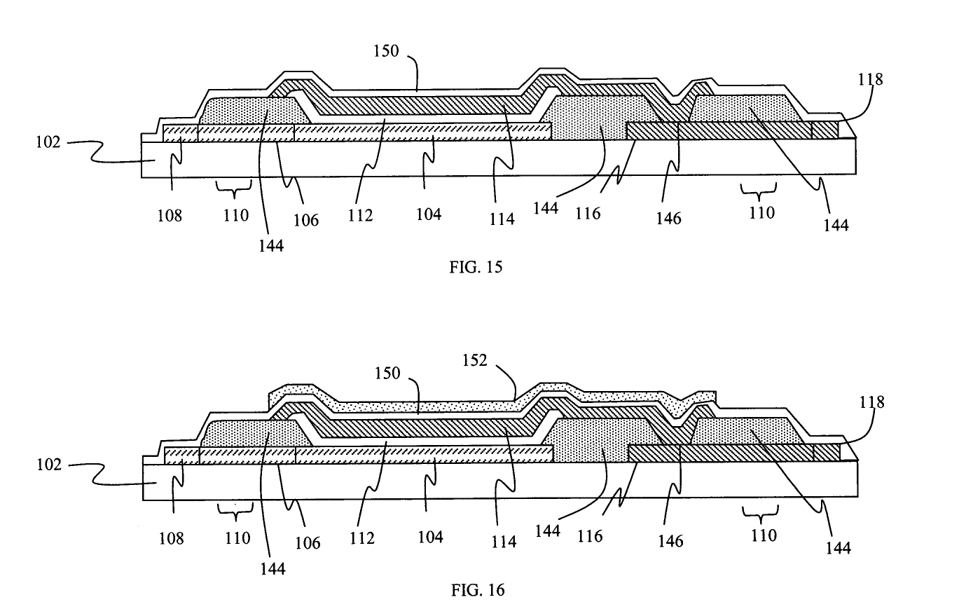

For further moisture protection, additional barrier layers can be used over the OLED device. For example, alternating layers of organic and inorganic layers can be provided. Because of their thermal sensitivity, it is important that organic barrier layers do not overlie the glass seal area. An example of the construction of such a structure is shown in cross sectional view in FIGS. 15-18. Starting with OLED device 300A as previously discussed in relation to FIGS. 10, 10A, and 10B, FIG. 15 shows a first organic barrier layer 150 deposited over the entire device. The organic barrier layer material can be monomeric or polymeric and can be deposited using vapor deposition or from solution. If cast from solution, it is important that the deposition solution does not negatively affect the OLED device.

Preferably, the organic barrier layer 150 is made of a polymeric material such as parylene materials, which can be deposited from a vapor phase to provide a polymer layer having excellent adhesion to, and step coverage over, topological features of the OLED devices, including defects such as particulate defects. The organic barrier layer 150 is typically formed in a thickness range of from 0.01 to 5 micrometer. However, by their very nature, the organic materials in the organic barrier layer 150 exhibit more moisture permeability than a layer formed of an inorganic dielectric material or a layer formed of a metal. Thus, it is desirable to encase the organic barrier layer with an inorganic material.

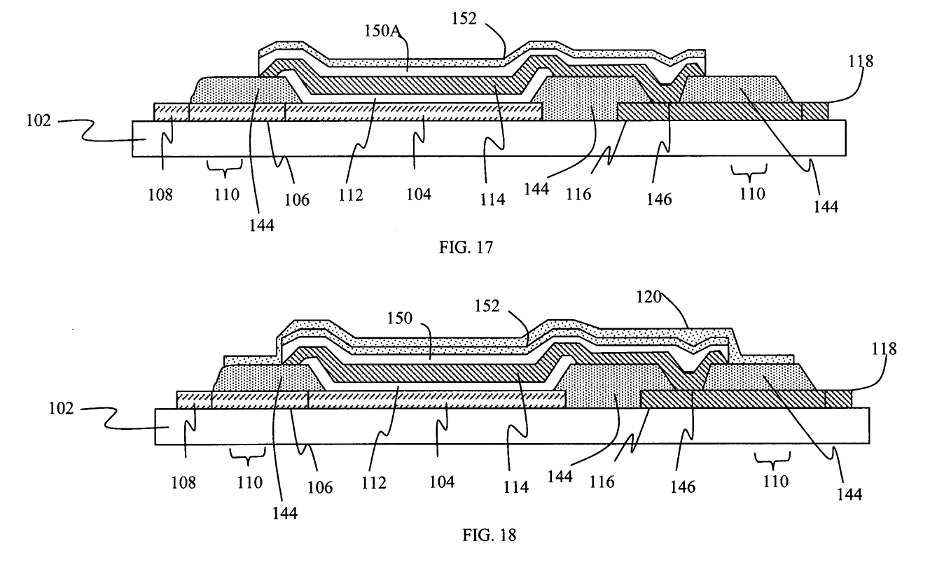

FIG. 16 shows a patterned inorganic barrier layer 152 deposited over the organic barrier layer 150. The patterned inorganic barrier layer 152 is deposited in a pattern, for example, using a shadow mask, so that it does not extend through the glass seal area 110. The patterned inorganic barrier layer 152 can be any of the same materials described previously in relation to the inorganic protection layer. In addition, the inorganic barrier layer can be a metal or metal alloy, for example, aluminum, gold, silver, molybdenum, tantalum nitride, titanium nitride, or tungsten. If light emission is desired through the cover, metal oxides or nitrides are preferred. The patterned inorganic barrier layer 152 can then be used as an etch mask, and the organic barrier layer 150 can be removed, for example, by plasma etch as known by those skilled in the art. This produces patterned organic barrier layer 150A, as shown in FIG. 17.

Next, as shown in FIG. 18, the inorganic protection layer 120 is provided over the assembly such that it extends through the glass seal area 110 but not over the contact pads. For even further protection, the steps described in FIGS. 15-18 can be repeated to produce one or more additional multilayer assemblies of organic and inorganic barrier layers.

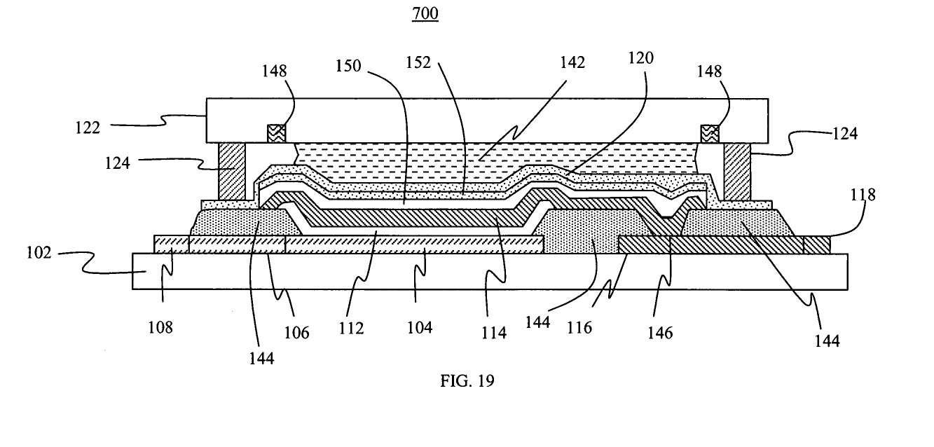

Then, by means previously described, a seventh embodiment of an encapsulated OLED device 700 shown in FIG. 19 can be formed by aligning a cover 122 with a glass frit seal material 124, and sealing it with a high-power radiation beam. In this embodiment, the cover contains a desiccant 148 at the perimeter and further contains a polymer buffer layer 142 adjoined to the cover 122 and the inorganic protection layer 120.

Although only a single OLED device has been shown, it is contemplated that several OLED devices can be formed and sealed on a single OLED substrate. Following the sealing step, singulation of various devices can be achieved by methods well known in the art, e.g, by physical cutting, scribe-and-breaking, laser cutting, etc. Alternatively, the devices can be cut first and then sealed. However, this is usually less preferred because the particles produced during the cutting can damage or contaminate the non-sealed OLED device.

Because moisture can adversely affect performance and operational lifetime of a non-encapsulated OLED devices, care is taken to maintain the devices in a moisture and dust-free environment until the OLED devices are fully encapsulated. Accordingly, in the drawings showing process sequences of encapsulating OLED devices, or of forming OLED devices, it should be considered that the devices are contained in a chamber held at a reduced pressure or in another moisture- and dust-free enclosure.

The present invention can be employed in most OLED device configurations. These include very simple structures comprising a single anode and cathode to more complex devices, such as passive matrix displays comprised of orthogonal arrays of anodes and cathodes to form pixels, and active matrix displays where each pixel is controlled independently, for example, with thin film transistors (TFTs).

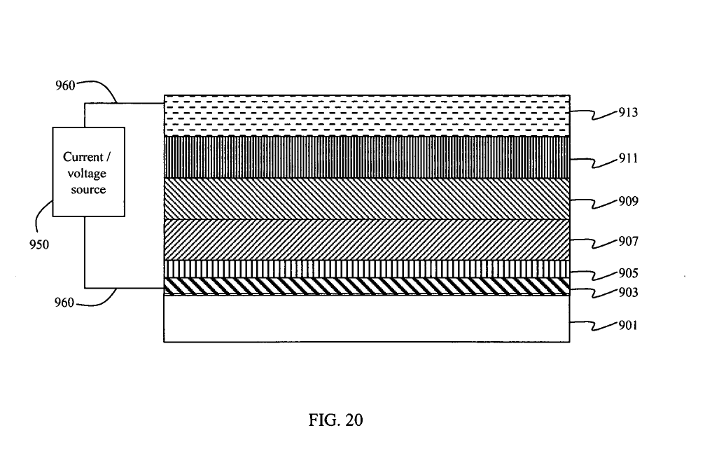

There are numerous configurations of the organic layers wherein the present invention can be successfully practiced. A typical but non-limiting structure is shown in FIG. 20 and is comprised of a substrate 901, an anode 903, a hole-injecting layer 905, a hole-transporting layer 907, a light-emitting layer 909, an electron-transporting layer 911, and a cathode 913. These layers are described in more detail below. Note that the substrate can alternatively be located adjacent to the cathode, or the substrate can actually constitute the anode or cathode. The organic layers between the anode and cathode are conveniently referred to as the organic EL media or organic EL media layer. The total combined thickness of the organic layers is preferably less than 500 nm.

The anode and cathode of the OLED are connected to a voltage/current source 950 through electrical conductors 960. The OLED is operated by applying a potential between the anode and cathode, such that the anode is at a more positive potential than the cathode. Holes are injected into the organic EL element from the anode and electrons are injected into the organic EL element at the anode. Enhanced device stability can sometimes be achieved when the OLED is operated in an AC mode where, for some time period in the cycle, the potential bias is reversed and no current flows. An example of an AC driven OLED is described in U.S. Pat. No. 5,552,678.

The OLED device of this invention is typically provided over a supporting substrate where either the cathode or anode can be in contact with the substrate. The substrate can have a simple or a complex structure with numerous layers, for example, a glass support with electronic elements such as TFT elements, planarizing layers, wiring layers, etc. The electrode in contact with the substrate is conveniently referred to as the bottom electrode. Conventionally, the bottom electrode is the anode, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. For applications where the EL emission is viewed through the top electrode, the transmissive characteristic of the bottom support is generally immaterial, and therefore can be light transmissive, light absorbing, or light reflective. Substrates for use in this case include, but are not limited to, glass, plastic, semiconductor materials, silicon, ceramics, and circuit board materials. Of course, it is necessary to provide in these device configurations a light-transparent top electrode.

When EL emission is viewed through anode 903, the anode should be transparent, or substantially transparent, to the emission of interest. Common transparent anode materials used in this invention are indium-tin oxide (ITO), indium-zinc oxide (IZO), and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode electrode, the transmissive characteristics of anode are generally immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well known photolithographic processes. Optionally, anodes can be polished prior to application of other layers to reduce surface roughness so as to reduce shorts or enhance reflectivity.

While not always necessary, it is often useful to provide a hole-injecting layer 905 between anode 903 and hole-transporting layer 907. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, plasma-deposited fluorocarbon polymers as described in U.S. Pat. Nos. 6,127,004, 6,208,075, and 6,208,077, some aromatic amines, for example, m-MTDATA (4,4′,4″-tris[(3-methylphenyl)phenylamino]triphenylamine), and inorganic oxides including vanadium oxide (VOx), molybdenum oxide (MoOx), and nickel oxide (NiOx). Alternative hole-injecting materials reportedly useful in organic EL devices are described in EP 0 891 121 A1 and EP 1 029 909 A1.

The hole-transporting layer 907 contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. The hole-transporting layer can be formed of a single or a mixture of aromatic tertiary amine compounds. Illustrative of useful aromatic tertiary amines are the following:
1,1-Bis(4-di-p-tolylaminophenyl)cyclohexane;
1,1-Bis(4-di-p-tolylaminophenyl)-4-phenylcyclohexane;
N,N,N′,N′-tetraphenyl-4,4′″-diamino-1,1′:4′,1″:4″,1′″-quaterphenyl;
Bis(4-dimethylamino-2-methylphenyl)phenylmethane;
1,4-bis[2-[4-[N,N-di(p-toly)amino]phenyl]vinyl]benzene (BDTAPVB);
N,N,N′,N′-Tetra-p-tolyl-4,4′-diaminobiphenyl;
N,N,N′,N′-Tetraphenyl-4,4′-diaminobiphenyl;
N,N,N′,N′-tetra-1-naphthyl-4,4′-diaminobiphenyl;
N,N,N′,N′-tetra-2-naphthyl-4,4′-diaminobiphenyl;
N-Phenylcarbazole;
4,4′-Bis[N-(1-naphthyl)-N-phenylamino]biphenyl (NPB);
4,4′-Bis[N-(1-naphthyl)-N-(2-naphthyl)amino]biphenyl (TNB);
4,4′-Bis[N-(1-naphthyl)-N-phenylamino]p-terphenyl;
4,4′-Bis[N-(2-naphthyl)-N-phenylamino]biphenyl;
4,4′-Bis[N-(3-acenaphthenyl)-N-phenylamino]biphenyl;
1,5-Bis[N-(1-naphthyl)-N-phenylamino]naphthalene;
4,4′-Bis[N-(9-anthryl)-N-phenylamino]biphenyl;
4,4′-Bis[N-(1-anthryl)-N-phenylamino]-p-terphenyl;
4,4′-Bis[N-(2-phenanthryl)-N-phenylamino]biphenyl;
4,4′-Bis[N-(8-fluoranthenyl)-N-phenylamino]biphenyl
4,4′-Bis[N-(2-pyrenyl)-N-phenylamino]biphenyl;
4,4′-Bis[N-(2-naphthacenyl)-N-phenylamino]biphenyl;
4,4′-Bis[N-(2-perylenyl)-N-phenylamino]biphenyl;
4,4′-Bis[N-(1-coronenyl)-N-phenylamino]biphenyl;
2,6-Bis(di-p-tolylamino)naphthalene;
2,6-Bis[di-(1-naphthyl)amino]naphthalene;
2,6-Bis[N-(1-naphthyl)-N-(2-naphthyl)amino]naphthalene;
N,N,N′,N′-Tetra(2-naphthyl)-4,4″-diamino-p-terphenyl;
4,4′-Bis{N-phenyl-N-[4-(1-naphthyl)-phenyl]amino}biphenyl;
2,6-Bis[N,N-di(2-naphthyl)amino]fluorene;
4,4′,4″-tris[(3-methylphenyl)phenylamino]triphenylamine (MTDATA); and
4,4′-Bis[N-(3-methylphenyl)-N-phenylamino]biphenyl (TPD).

Another class of useful hole-transporting materials includes polycyclic aromatic compounds as described in EP 1 009 041. Some hole-injecting materials described in EP 0 891 121 A1 and EP 1 029 909 A1 can also make useful hole-transporting materials. In addition, polymeric hole-transporting materials can be used including poly(N-vinylcarbazole) (PVK), polythiophenes, polypyrrole, polyaniline, and copolymers including poly(3,4-ethylenedioxy-thiophene)/poly(4-styrenesulfonate), also called PEDOT/PSS.

As more fully described in U.S. Pat. Nos. 4,769,292 and 5,935,721, the light-emitting layer(s) (LEL) 909 of the organic EL element includes a luminescent fluorescent or phosphorescent material where electroluminescence is produced as a result of electron-hole pair recombination in this region. The light-emitting layer can be comprised of a single material, but more commonly contains a host material doped with a guest emitting material or materials where light emission comes primarily from the emitting materials, and can be of any color. This guest emitting material is often referred to as a light-emitting dopant. The host materials in the light-emitting layer can be an electron-transporting material, as defined below, a hole-transporting material, as defined above, or another material or combination of materials that support hole-electron recombination. The emitting material is usually chosen from highly fluorescent dyes and phosphorescent compounds, e.g., transition metal complexes as described in WO 98/55561, WO 00/18851, WO 00/57676, and WO 00/70655. Emitting materials are typically incorporated at 0.01 to 10% by weight of the host material.

The host and emitting materials can be small nonpolymeric molecules or polymeric materials including polyfluorenes and polyvinylarylenes, e.g., poly(p-phenylenevinylene), PPV. In the case of polymers, small molecule emitting materials can be molecularly dispersed into a polymeric host, or the emitting materials can be added by copolymerizing a minor constituent into a host polymer.

An important relationship for choosing an emitting material is a comparison of the bandgap potential, which is defined as the energy difference between the highest occupied molecular orbital and the lowest unoccupied molecular orbital of the molecule. For efficient energy transfer from the host to the emitting material, a necessary condition is that the bandgap of the dopant is smaller than that of the host material. For phosphorescent emitters (including materials that emit from a triplet excited state, i.e., so-called “triplet emitters”) it is also important that the host triplet energy level of the host be high enough to enable energy transfer from host to emitting material.

Host and emitting materials known to be of use include, but are not limited to, those disclosed in U.S. Pat. Nos. 4,768,292, 5,141,671, 5,150,006, 5,151,629, 5,405,709, 5,484,922, 5,593,788, 5,645,948, 5,683,823, 5,755,999, 5,928,802, 5,935,720, 5,935,721, 6,020,078, 6,475,648, 6,534,199, 6,661,023, and U.S. Patent Application Publications 2002/0127427 A1, 2003/0198829 A1, 2003/0203234 A1, 2003/0224202 A1, and 2004/0001969 A1.

Metal complexes of 8-hydroxyquinoline (oxine) and similar derivatives constitute one class of useful host compounds capable of supporting electroluminescence. Illustrative of useful chelated oxinoid compounds are the following:
CO-1: Aluminum trisoxine [alias, tris(8-quinolinolato)aluminum(III)];
CO-2: Magnesium bisoxine [alias, bis(8-quinolinolato)magnesium(II)];
CO-3: Bis[benzo{f}-8-quinolinolato]zinc (II);
CO-4: Bis(2-methyl-8-quinolinolato)aluminum(III)-μ-oxo-bis(2-methyl-8-quinolinolato) aluminum(III);
CO-5: Indium trisoxine [alias, tris(8-quinolinolato)indium];
CO-6: Aluminum tris(5-methyloxine) [alias, tris(5-methyl-8-quinolinolato) aluminum(III)];
CO-7: Lithium oxine [alias, (8-quinolinolato)lithium(I)];
CO-8: Gallium oxine [alias, tris(8-quinolinolato)gallium(III)]; and
CO-9: Zirconium oxine [alias, tetra(8-quinolinolato)zirconium(IV)].

Another class of useful host materials includes derivatives of anthracene, such as those described in U.S. Pat. Nos. 5,935,721, 5,972,247, 6,465,115, 6,534,199, 6,713,192, U.S. Patent Application Publications 2002/0048687 A1, 2003/0072966 A1 and WO 2004/018587. Some examples include derivatives of 9,10-dinaphthylanthracene derivatives and 9-naphthyl-10-phenylanthracene. Other useful classes of host materials include distyrylarylene derivatives as described in U.S. Pat. No. 5,121,029, and benzazole derivatives, for example, 2,2′,2″-(1,3,5-phenylene)tris[1-phenyl-1H-benzimidazole].

Desirable host materials are capable of forming a continuous film. The light-emitting layer can contain more than one host material in order to improve the device's film morphology, electrical properties, light emission efficiency, and lifetime. Mixtures of electron-transporting and hole-transporting materials are known as useful hosts. In addition, mixtures of the above listed host materials with hole-transporting or electron-transporting materials can make suitable hosts.

Useful fluorescent dopants include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrilium and thiapyrilium compounds, fluorene derivatives, periflanthene derivatives, indenoperylene derivatives, bis(azinyl)amine boron compounds, bis(azinyl)methane compounds, derivatives of distryrylbenzene and distyrylbiphenyl, and carbostyryl compounds. Among derivatives of distyrylbenzene, particularly useful are those substituted with diarylamino groups, informally known as distyrylamines.

Phosphorescent Emitters

Suitable host materials for phosphorescent emitters (including materials that emit from a triplet excited state, i.e., so-called “triplet emitters”) should be selected so that the triplet exciton can be transferred efficiently from the host material to the phosphorescent material. For this transfer to occur, it is a highly desirable condition that the excited state energy of the phosphorescent material be lower than the difference in energy between the lowest triplet state and the ground state of the host. However, the bandgap of the host should not be chosen so large as to cause an unacceptable increase in the drive voltage of the OLED. Suitable host materials are described in WO 00/70655 A2; WO 01/39234 A2; WO 01/93642 A1; WO 02/074015 A2; WO 02/15645 A1, and U.S. Patent Application Publication 2002/0117662 A1. Suitable hosts include certain aryl amines, triazoles, indoles, and carbazole compounds. Examples of desirable hosts are 4,4′-N,N′-dicarbazole-biphenyl (CBP), 2,2′-dimethyl-4,4′-N,N′-dicarbazole-biphenyl, m-(N,N′-dicarbazole)benzene, and poly(N-vinylcarbazole), including their derivatives.

Examples of useful phosphorescent materials that can be used in light-emitting layers of this invention include, but are not limited to, those described in WO 00/57676, WO 00/70655, WO 01/41512 A1, WO 02/15645 A1, U.S. Patent Application Publication 2003/0017361 A1, WO 01/93642 A1, WO 01/39234 A2, U.S. Pat. No. 6,458,475 B1, WO 02/071813 A1, U.S. Pat. No. 6,573,651 B2, U.S. Patent Application Publication 2002/0197511 A1, WO 02/074015 A2, U.S. Pat. No. 6,451,455 B1, U.S. Patent Application Publications 2003/0072964 A1 and 2003/0068528 A1, U.S. Pat. Nos. 6,413,656 B1, 6,515,298 B2, 6,451,415 B1, 6,097,147, U.S. Patent Application Publications 2003/0124381 A1, 2003/0059646 A1, 2003/0054198 A1, EP 1 239 526 A2, EP 1 238 981 A2, EP 1 244 155 A2, U.S. Patent Application Publications 2002/0100906 A1, 2003/0068526 A1, 2003/0068535 A1, JP 2003073387A, JP 2003073388A, U.S. Patent Application Publications 2003/0141809 A1 and 2003/0040627 A1, JP 2003059667A, JP 2003073665A, and U.S. Patent Application Publication 2002/0121638 A1.

Preferred thin film-forming materials for use in forming the electron-transporting layer 911 of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary oxinoid compounds were listed previously.

Other electron-transporting materials include various butadiene derivatives as disclosed in U.S. Pat. No. 4,356,429 and various heterocyclic optical brighteners as described in U.S. Pat. 4,539,507. Benzazoles and triazines are also useful electron-transporting materials.

When light emission is viewed solely through the anode, the cathode 913 used in this invention can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the organic layer (e.g., ETL), which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059,861, 5,059,862, and 6,140,763.

A metal-doped organic layer can be used as an electron-injecting layer. Such a layer contains an organic electron-transporting material and a low work-function metal (<4.0 eV). For example, Kido et al. reported in “Bright Organic Electroluminescent Devices Having a Metal-Doped Electron-Injecting Layer”, Applied Physics Letters, 73, 2866 (1998) and disclosed in U.S. Pat. No. 6,013,384 that an OLED can be fabricated containing a low work-function metal-doped electron-injecting layer adjacent to a cathode. Suitable metals for the metal-doped organic layer include alkali metals (e.g. lithium, sodium), alkaline earth metals (e.g. barium, magnesium), metals from the lanthanide group (e.g. lanthanum, neodymium, lutetium), or combinations thereof. The concentration of the low work-function metal in the metal-doped organic layer is in the range of from 0.1% to 30% by volume. Preferably, the concentration of the low work-function metal in the metal-doped organic layer is in the range of from 0.2% to 10% by volume. Preferably, the low work-function metal is provided in a mole ratio in a range of from 1:1 with the organic electron transporting material.

When light emission is viewed through the cathode, the cathode must be transparent or partially transparent. For such applications, metals must be thin or one must use transparent conductive oxides, or include these materials. Optically transparent cathodes have been described in more detail in U.S. Pat. Nos. 4,885,211, 5,247,190, JP 3,234,963, U.S. Pat. Nos. 5,703,436, 5,608,287, 5,837,391, 5,677,572, 5,776,622, 5,776,623, 5,714,838, 5,969,474, 5,739,545, 5,981,306, 6,137,223, 6,140,763, 6,172,459, EP 1 076 368, and U.S. Pat. Nos. 6,278,236 and 6,284,393. Cathode materials are typically deposited by evaporation, sputtering, or chemical vapor deposition. When needed, patterning can be achieved through many well known methods including, but not limited to, through-mask deposition, integral shadow masking, for example, as described in U.S. Pat. No. 5,276,380 and EP 0 732 868, laser ablation, and selective chemical vapor deposition.

In some instances, layers 909 and 911 can optionally be collapsed into a single layer that serves the function of supporting both light emission and electron transportation. It also known in the art that emitting dopants can be added to the hole-transporting layer, which can serve as a host. Multiple dopants can be added to one or more layers in order to produce a white-emitting OLED, for example, by combining blue- and yellow-emitting materials, cyan- and red-emitting materials, or red-, green-, and blue-emitting materials. White-emitting devices are described, for example, in EP 1 187 235, EP 1 182 244, U.S. Pat. Nos. 5,683,823, 5,503,910, 5,405,709, and 5,283,182, U.S. Patent Application Publications 2002/0186214 A1, 2002/0025419 A1, 2004/0009367 A1, and U.S. Pat. No. 6,627,333.

Additional layers such as exciton, electron and hole-blocking layers as taught in the art can be employed in devices of this invention. Hole-blocking layers are commonly used to improve efficiency of phosphorescent emitter devices, for example, as in U.S. Patent Application Publication 2002/0015859 A1, WO 00/70655 A2, WO 01/93642 A1, and U.S. Patent Application Publications 2003/0068528 A1 and 2003/0175553 A1.

This invention can be used in so-called stacked device architecture, for example, as taught in U.S. Pat. Nos. 5,703,436, and 6,337,492, and U.S. Patent Application Publication 2003/0170491 A1.

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimation “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimation boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. Nos. 5,688,551, 5,851,709 and 6,066,357) and inkjet method (U.S. Pat. No. 6,066,357).

OLED devices of this invention can employ various well known optical effects in order to enhance its properties if desired. This includes optimizing layer thicknesses to yield maximum light transmission, providing dielectric mirror structures, replacing reflective electrodes with light-absorbing electrodes, providing anti glare or anti-reflection coatings over the display, providing a polarizing medium over the display, or providing colored, neutral density, or color conversion filters in functional relationship with the light-emitting areas of the display. Filters, polarizers, and anti-glare or anti-reflection coatings can be also provided over a cover or as part of a cover.

The OLED device can have a microcavity structure. In one useful example, one of the metallic electrodes is essentially opaque and reflective; the other one is reflective and semitransparent. The reflective electrode is preferably selected from Au, Ag, Mg, Ca, or alloys thereof. Because of the presence of the two reflecting metal electrodes, the device has a microcavity structure. The strong optical interference in this structure results in a resonance condition. Emission near the resonance wavelength is enhanced and emission away from the resonance wavelength is depressed. The optical path length can be tuned by selecting the thickness of the organic layers or by placing a transparent optical spacer between the electrodes. For example, an OLED device of this invention can have ITO spacer layer placed between a reflective anode and the organic EL media, with a semitransparent cathode over the organic EL media.

### EXAMPLES

In order to demonstrate the effectiveness of the embodiments and methods of this invention, OLED devices were encapsulated in a manner described herein and were subjected to tests that are customary to display evaluation. Examples of possible assessment criteria include changes in electrical resistance of the display interconnect lines, changes in seal bond strength and moisture permeation into the encapsulate device under certain prolonged environmental conditions. One method to evaluate the level of moisture permeation is to observe the formation of dark spots in the display area. An alternative method to evaluate levels of moisture permeation is to observe the change in optical density of a Ca coating that is deposited onto a portion of the inside surface of a glass cover by means of vapor deposition. If moisture is present inside the space enclosed by the encapsulation, it reacts with the Ca coating forming CaO and reducing the optical density of the patch.

Measurement of the interconnect resistance across the glass seal area can be made by constructing a test vehicle comprising an encapsulated display device but omitting the layers typically coated between the cathode and the anode coatings. In this type of test vehicle the cathode provides electrical continuity between all interconnect lines and associated contact pads and permits a method to measure any significant changes in resistance of the interconnect lines, including the interconnect line portion that resides under the seal area, without having to physically remove the cover. To determine the effects of the sealing process on interconnect lines, the resistance is measured with an ohm meter across two contact pads corresponding to two interconnect lines before and after the sealing process.

For comparison, a test vehicle was first constructed without an inorganic protection layer coated over the glass frit seal area. Before sealing, the resistance of all indium tin oxide interconnect line pairs were measured and shown to have acceptable resistance levels. After sealing the glass frit with a laser, measurement of the interconnect line resistances show non-continuity in 92% of the interconnect lines tested. A test vehicle was then constructed with an inorganic protection layer over the display area and extending into the seal area having 100 nm of aluminum oxide over the indium tin oxide interconnect lines. Measurement of interconnect lines showed no significant changes in interconnect line resistance during the laser sealing process in all samples measured. Further testing indicated that extending the inorganic protection layer from the device display area into the glass frit seal area also provided a greater degree of freedom when choosing laser power and sealing speeds in an effort to maximize seal hermeticity.

Evaluation of relative seal bond strength can be made by recording the degree of difficulty that is experience in prying off the attached cover glass. Comparison of laser sealed test vehicles with and with out inorganic protection layers that extend from the device display area into the glass frit seal area indicates higher bond strength in samples that included the extended protection layer. This increased bond strength was further indicated by the occurrence of local failure of the substrate and cover surfaces at the frit bond interfaces in only those test vehicles that included the extended protection layer.

As described previously, the evaluation of moisture permeation can be made by measuring the change in optical density of a Ca coating deposited inside the encapsulated device or test vehicle upon subjecting the device to a known environmental condition. To evaluation the effects of the extended inorganic protection layer on hermeticity, a number of test vehicles comprising a laser frit seal, an extended protection layer and a Ca coating on a portion of the inside surface of the glass cover were constructed using different laser settings and then subjected to 85 degree C/85% relative humidity for 1000 hours. Results indicated no change in optical density for many of the laser conditions used during the sealing process.

The invention has been described in detail with particular reference to certain preferred embodiments thereof, but it will be understood that variations and modifications can be effected within the spirit and scope of the invention.

### Parts List

100 encapsulated OLED device
100A OLED device
100B OLED device after deposition of inorganic protection layer
102 OLED substrate
104 first electrode
106 first interconnect line
108 first electrical contact pad
110 glass seal area
112 organic El media layer
114 second electrode
116 second interconnect line
118 second contact pad
120 inorganic protection layer
122 cover
124 glass frit seal material
126 pedestal
128 pressure plate
130 pressure
132 high-power beam
134 lens
136 mirror
138 high-power beam source
140 space
142 polymer buffer layer
144 inorganic insulation and protection layer
146 via
148 desiccant
150 organic barrier layer
150A patterned organic barrier layer
152 patterned inorganic barrier layer
200 encapsulated OLED device
300 encapsulated OLED device
300A OLED device
400 encapsulated OLED device
500 encapsulated OLED device
600 encapsulated OLED device
700 encapsulated OLED device
901 substrate
903 anode
905 hole-injecting layer
907 hole-transporting layer
909 light-emitting layer
911 electron-transporting layer
913 cathode
950 voltage/current source
960 electrical conductors

1. An encapsulated OLED device comprising:
a) a substrate having a predetermined glass seal area and defining a sealed region;
b) one or more OLED unit(s) provided over the substrate, each OLED unit having a light-emitting portion including at least one first electrode, at least one second electrode spaced from the first electrode, and an organic EL media layer provided between the first and second electrodes, wherein the light-emitting portion is provided within the sealed region;
c) an inorganic protection layer provided over the glass seal area and over at least a portion of the sealed region;
d) a cover provided over the substrate and OLED unit(s); and
e) sintered glass frit seal material provided in the glass seal area and in contact with both the cover and the inorganic protection layer, so as to bond the cover to the inorganic protection layer and provide a seal against moisture penetration into the sealed region.

2. The encapsulated OLED device of claim 1 wherein the inorganic protection layer is provided over the entire sealed region.

3. The encapsulated OLED device of claim 1 wherein the inorganic protection layer contains a metal oxide, a metal nitride, a metal oxynitride, or diamond-like carbon.

4. The encapsulated OLED device of claim 3 wherein the inorganic protection layer is aluminum oxide, silicon dioxide, silicon nitride, or silicon oxynitride.

5. The encapsulated OLED device of claim 3 wherein the inorganic protection layer is provided by thermal physical vapor deposition, sputter deposition, electron beam deposition, chemical vapor deposition, plasma-enhanced chemical vapor deposition, or laser-induced chemical vapor deposition.

6. The encapsulated OLED device of claim 3 wherein the inorganic protection layer is provided by atomic layer deposition.

7. The encapsulated OLED device of claim 2 further comprising:
f) one or more contact pads provided over the substrate outside of the sealed region; and
g) one or more interconnect lines provided over the substrate and in electrical connection between the contact pads and the first or second electrodes or both, wherein the interconnect line(s) extend through the glass seal area, and the inorganic protection layer is provided over the interconnect line(s) at least in the glass seal area, but not over at least a portion of the contact pad(s).

8. The encapsulated OLED device of claim 7 wherein the OLED device is top-emitting and the cover is glass.

9. The encapsulated OLED device of claim 7 wherein the inorganic protection layer contains a metal oxide, a metal nitride, a metal oxynitride, or diamond-like carbon.

10. The encapsulated OLED device of claim 7 wherein the inorganic protection layer is aluminum oxide, silicon dioxide, silicon nitride, or silicon oxynitride.

11. The encapsulated OLED device of claim 9 wherein the inorganic protection layer is provided by thermal physical vapor deposition, sputter deposition, electron beam deposition, chemical vapor deposition, plasma-enhanced chemical vapor deposition, or laser-induced chemical vapor deposition.

12. The encapsulated OLED device of claim 9 wherein the inorganic protection layer is provided by atomic layer deposition.

13. The encapsulated OLED device of claim7 wherein a desiccant or a getter material is provided inside the sealed region.

14. The encapsulated OLED device of claim 7 wherein a polymer buffer layer is provided within a portion of the sealing area between the inorganic protection layer and the cover, but not in the glass seal area.

15. The encapsulated OLED device of claim 14 wherein the OLED device is top-emitting and the cover is glass.

16. The encapsulated OLED device of claim 15 wherein a desiccant or a getter material is provided inside the sealed region.

17. The encapsulated OLED device of claim 16 wherein the desiccant or getter is provided at the perimeter region of the cover between where the glass frit sealing material and the polymer buffer layer contact the cover.

18. The encapsulated OLED device of claim 14 wherein a desiccant or a getter material is provided inside the sealed region.

19. The encapsulated OLED device of claim 7 wherein the interconnect line contains a conductive metal oxide.

20. The encapsulated OLED device of claim 19 wherein the conductive metal oxide is indium tin oxide or indium zinc oxide.

21. The encapsulated OLED device of claim 7 wherein the interconnect line contains conductive metal.

22. The encapsulated OLED device of claim 21 wherein the interconnect line contains aluminum or molybdenum or both.

23. The encapsulated OLED device of claim 7 wherein there is a plurality of OLED units emitting red, green, and blue light.

24. The encapsulated OLED device of claim 7 wherein the adhesion of the sintered glass frit seal material to the inorganic protection layer is greater than the adhesion of the sintered glass frit seal material to the substrate or to the interconnect line.

25. An encapsulated OLED device comprising:
a) a substrate having a predetermined glass seal area and defining a sealed region;
b) one or more first electrode(s) provided over the substrate and within the sealed region;
c) an inorganic insulation and protection layer provided over the glass seal area and over a portion of the first electrode(s);
d) organic EL media provided over the first electrode(s), and one or more second electrode(s) provided over the organic EL media so as to form one or more OLED unit(s), each having a light-emitting portion, wherein the light-emitting portion is provided within the sealed region;
e) a cover provided over the substrate and OLED unit(s); and
f) sintered glass frit seal material provided in the glass seal area and in contact with both the cover and the inorganic insulation and protection layer, so as to bond the cover to the inorganic insulation and protection layer and provide a seal against moisture penetration into the sealed region.

26. An encapsulated OLED device comprising:
a) a substrate having a predetermined glass seal area and defining a sealed region;
b) one or more first electrode(s) provided over the substrate and within the sealed region;
c) an inorganic insulation and protection layer provided over the glass seal area and over a portion of the first electrode(s);
d) organic EL media provided over the first electrode(s) and one or more second electrode(s) provided over the organic EL media so as to form one or more OLED units, each having a light-emitting portion, wherein the light-emitting portion is provided within the sealed region;
e) an inorganic protection layer provided over the glass seal area and over the sealed region;
f) a cover provided over the substrate and OLED unit(s); and
g) sintered glass frit seal material provided in the glass seal area and in contact with both the cover and the inorganic protection layer, so as to bond the cover to the inorganic protection layer and provide a seal against moisture penetration into the sealed region.

27. The encapsulated OLED device of claim 26 further comprising:
h) one or more contact pads provided over the substrate outside of the sealed region; and
i) one or more interconnect lines provided over the substrate and in electrical connection between the contact pads and the first or second electrodes or both, wherein the interconnect line(s) extend through the glass seal area, and the inorganic insulation and protection layer is provided over the interconnect line(s) at least in the glass seal area, but not over at least a portion of the contact pad(s).

28. The invention of claim 1 further including means for providing laser light that sinters the glass frit seal material so as to bond the cover to the inorganic protection layer.
